(19) United States
(12) Patent Application Publication
(10) Pub. No.: US 2008/0251316 A1
(43) Pub. Date: Oct. 16, 2008

(54) SCAFFOLD ACCESS LADDER BRACKET ASSEMBLY

(75) Inventors: Scott David Libert, Greenfield, WI (US); Robert P. Wiegers, Waukesha, WI (US)

Correspondence Address: WHYTE HIRSCHBOECK DUDEK S C, 555 EAST WELLS STREET, SUITE 1900, MILWAUKEE, WI, 53202, US

(73) Assignee: THYSSENKRUPP SAFWAY, INC., Waukesha, WI (US)

(21) Appl. No.: 11/734,725

(22) Filed: Apr. 12, 2007

(51) Int. Cl. E06C 7/16; E06C 7/14

(52) U.S. Cl. 182/115; 248/211

(57) ABSTRACT

A scaffold access ladder bracket assembly is shown and described. The assembly can be used to attach an access ladder having side rails to a scaffold. The assembly includes a bracket body that includes bent portion terminating in hooked ends. The hooked ends wedge the bracket body against the side rails. The assembly also can include ramped portions connected to the bent portion and spaced apart from the hooked ends to create ladder receiving channels for receiving the ladder side rails. And the assembly includes a locking mechanism connected to the bracket body for lockably engaging the bracket body to ladder side rails. Also disclosed is a method of installing a scaffold access ladder on a scaffold using the assembly. The assembly provides a bracket assembly that requires no tools to install and/or dismantle in at least some instances (e.g., when the assembly is connected to a ladder), and thus, is easy to use and handle.

### FIELD OF THE INVENTION

The invention relates generally to stabilizing brackets, and more particularly to a scaffold bracket assembly for securing a ladder or the like to a scaffold.

### BACKGROUND

Scaffold systems have been used for hundreds of years to provide temporary support for repair, maintenance and/or construction of an area or nearby structure (e.g., a building). Scaffold access ladders are used with scaffold systems to permit workers to access various scaffold levels and sections.

Ladders have typically been secured to scaffolds using brackets or bracket assemblies that have themselves been secured by ropes, clamps, fasteners and the like. While such solutions have resulted in some degree of success, it would be desirable to increase the speed of assembling and/or dismantling of scaffold systems. Moreover, if possible, it would be desirable to improve or increase safety.

Further, ladders are typically secured via brackets in a manual fashion. As such, it would be desirable if such brackets did not require tools to accomplish such attachment.

In general, while scaffold systems have been improved with regard to ease of use, safety and stability, there is still a need in the industry to provide various components, including ladder bracket assemblies that can provide the aforementioned benefits. Accordingly, it would be desirable to provide a scaffold access ladder bracket assembly and a method for installing such ladders that provides for swift installation and dismantling of scaffold access ladders.

### SUMMARY

In accordance with at least one aspect of the present invention, a scaffold access ladder bracket assembly is disclosed herein. The assembly comprises: a bracket body that includes bent portion terminating in a pair of hooked ends, the hooked ends for wedging the bracket body against a pair of ladder side rails, and a pair of ramped portions connected to the bent portion and spaced apart from the pair of hooked ends to create a pair of ladder receiving channels for receiving the pair of ladder side rails. In at least some embodiments, the assembly can include a locking mechanism connected to the bracket body for lockably engaging the bracket body to side rails of ladder. Various other embodiments of the bracket assembly are disclosed, contemplated and considered within the scope of the present invention.

In accordance with another aspect of the present invention, a method of installing a scaffold access ladder having a pair of side rails on a scaffold is disclosed herein. The method includes: providing a scaffold access ladder bracket assembly and the assembly includes: 1) a bracket body that includes bent portion terminating in a pair of hooked ends, the hooked ends for wedging the bracket body against a pair of ladder side rails, and a pair of ramped portions connected to the bent portion and spaced apart from the pair of hooked ends to create a pair of ladder receiving channels for receiving the pair of ladder side rails; and, in at least some embodiments: 2) a locking mechanism connected to the bracket body for lockably engaging the bracket body to side rails of ladder. The method further includes orienting the bracket assembly with respect to the ladder side rails such that the ladder receiving channels can receive the pair of ladder side rails. The method still further includes initially engaging the bracket assembly onto the ladder such that the ladder side rails are positioned within, or substantially within, the ladder receiving channels. And the method further includes rotating at least one of the bracket assembly and the ladder until the hooked ends of the bracket assembly are in wedged contact around the ladder side rails and such that the ladder is secured to and engaged with the bracket assembly. Various other embodiments of the method are disclosed, contemplated and considered within the scope of the present invention.

In accordance with at least another aspect of the present invention, disclosed herein is a scaffold access ladder bracket assembly in combination with a ladder. The combination comprises: 1) a ladder having a pair of side rails and a plurality of cross pieces connected the side rails; and 2) a scaffold access ladder bracket assembly. The assembly includes: a) a bracket body that includes bent portion terminating in a pair of hooked end portions, the hooked end portions for wedging the bracket body against a pair of ladder side rails, and a pair of ramped portions connected to the bent portion and spaced apart from the pair of hooked ends to create a pair of ladder receiving channels for receiving the pair of ladder side rails; and, in at least some embodiments: b) a locking mechanism connected to the bracket body for lockably engaging the bracket body to side rails of ladder. The bracket assembly can thus be lockably and securably engaged with the ladder by rotating the ladder within the ladder receiving channels. Various other embodiments of the combination are disclosed, contemplated and considered within the scope of the present invention.

In accordance with at least another aspect of the present invention, disclosed herein is scaffold access ladder bracket assembly, the assembly comprising: a bracket body that includes a bent portion terminating in a pair of hooked ends, the hooked ends for wedging the bracket body against a pair of ladder side rails, and a pair of ramped portions connected to the bent portion and spaced apart from the pair of hooked ends to create a pair of ladder receiving channels for receiving the pair of ladder side rails; and wherein the bracket assembly is securably engaged with the ladder by rotating the ladder side rails within and/or with respect to the ladder receiving channels. Various other embodiments of the assembly are disclosed, contemplated and considered within the scope of the present invention

The inventive assembly, which attaches scaffold access ladders to scaffolds, allows for quicker and easier installation and dismantling of scaffold assemblies, and scaffold access ladders in particular, when compared to prior solutions. This, in turn, results in a reduction of costs (e.g., reduced labor costs) associated with the building or erection of scaffolds. Additionally and advantageously, the time to erect a scaffold is reduced. Further, the inventive assembly eliminates (or at least substantially eliminates) the need for using tools in the attachment of the assembly to the ladder.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. Like reference numerals are used to indicate like components. In the drawings:

FIG. 1 is a perspective view of one embodiment of a scaffold assembly including a pair of inventive scaffold access ladder bracket assemblies attached to a ladder and connected to a scaffold joint of a conventional scaffolding system in accordance with at least one aspect of the present invention;

FIG. 2 is an enlarged view of the assembly of FIG. 1 further illustrating various features of the invention;

FIG. 3 is a view similar of that of FIG. 2, showing one embodiment of the inventive scaffold access ladder bracket assembly in solid and showing other assembly components in phantom;

FIG. 4 is a side view of the ladder and the scaffold access ladder bracket assembly showing one aspect of installing or otherwise securing the ladder to the scaffold access ladder bracket assembly;

FIG. 5 is a top view of FIG. 4 illustrating another aspect of such installation;

FIG. 6 is a side view of the ladder and the scaffold access ladder bracket assembly showing still another aspect of such installation;

FIG. 7 illustrates a top view of the ladder and the scaffold access ladder bracket assembly showing the ladder connected to the assembly and secured to a conventional scaffold joint;

FIG. 8 is a sectional view of the scaffold access ladder bracket assembly taken along line 8-8 of FIG. 7;

FIG. 9 is a top perspective view taken along line 9-9 of FIG. 8; and

FIGS. 10-13 illustrate enlarged views showing various aspects and/or embodiments of the present invention during and following installation.

Various items of equipment, such as fittings, fasteners, etc., have been omitted from the drawings so as to simplify the description of the invention. However, those skilled in the art will realize that such conventional equipment can be, and are, employed as desired.

### DESCRIPTION OF THE INVENTION

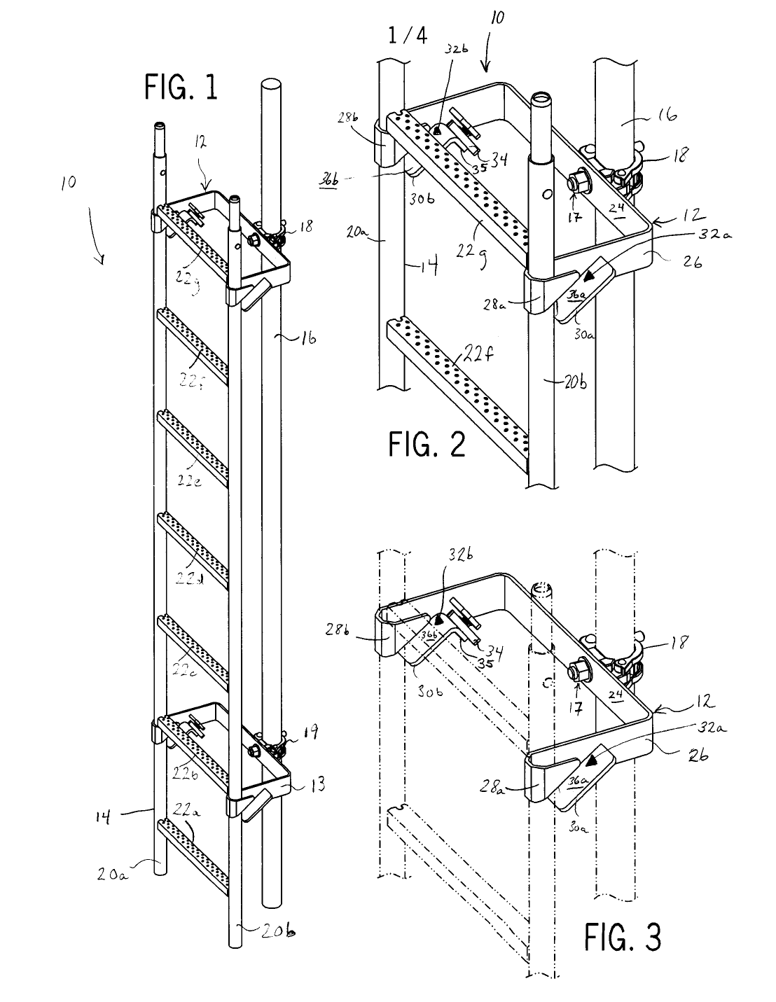

In accordance with at least one aspect of the present invention, FIG. 1 is a perspective view of an assembly 10 including a pair of inventive scaffold access ladder bracket assemblies 12, 13 attached to a ladder 14. Each of the brackets 12, 13 is shown securably connected to a scaffold joint 16 of a conventional scaffolding system (not shown) via a clamp mechanism 18, 19, respectively. As shown, the ladder is a typical structure that includes, as shown, two side pieces 20a-b which are round and which are joined at regular intervals by crosspieces 22a-g onto which a scaffold worker may step such that (s)he can climb up or down, so as to access, various levels of a typical scaffold system (not shown). The crosspieces 22a-g are typically substantially parallel with one another, and as shown, include a surface that provides traction for facilitating climbing thereon by the scaffold worker. The number of crosspieces can vary to convenience. The components shown and described here are typically constructed of steel. One scaffold system contemplated for use in the present invention is the Safway® Systems Scaffold, manufactured by ThyssenKrupp Safway, Inc., located in Waukesha, Wis.

FIG. 2 is an enlarged view of a portion the assembly 10 of FIG. 1 further illustrating various features of one embodiment of the inventive scaffold access ladder bracket assembly 12. As noted above, the bracket is again shown connected to a scaffold joint 16 of a scaffold system via clamp mechanism 18, as well as a ladder 14 having side rails 20a-b and cross members 22f-g (the remaining cross members shown in FIG. 1 are no longer shown). FIG. 3 is a view similar to that of FIG. 2, but showing only the inventive scaffold access ladder bracket assembly 12 in solid while showing other assembly components (e.g., the ladder, the scaffold joint, etc.) in phantom.

Referring to FIGS. 2-3, the scaffold access ladder bracket assembly 12 comprises a bracket body 24 that includes bent portion 26 terminating in a pair of hooked ends 28a-b (also referred to as “hooked end portions” or “hooked-like ends”). The hooked ends are for wedging the bracket body 24 against the ladder side rails 20a-b (FIG. 2). The bracket assembly 10 further includes a pair of ramped portions 30a-b connected to the bent portion 26 and spaced apart from the pair of hooked ends 28a-b to create a pair of ladder receiving channels 32a-b. Ladder receiving channels 32a-b serve to receive the pair of ladder side rails 20a-b (FIG. 2). In accordance with at least some embodiments, and as illustrated, the bracket assembly further includes a locking mechanism 34 connected to the bracket body 24. In one embodiment and as shown, the locking mechanism 34 is connected to ramped portion 30b, and more specifically a locking mechanism support portion 35 of the ramped portion 30b. The locking mechanism 34 is capable of lockably engaging the bracket body 24 to the side rails 20a-b of ladder 14 (FIG. 2). In at least one embodiment and as shown, the bracket assembly further includes clamping mechanism 18 for connecting the bracket body 24 to the illustrated scaffold joint 16 (FIG. 2), via, for example, a nut and bolt combination 17. Hooked ends 28a-b are used to create a rigid connection between the bracket body and the side rails. In at least one embodiment and as shown, the hooked portions 28a-b at least partially encapsulate the side rails of the ladder. Further, in at least one embodiment, and as illustrated, the side rails 20a-b of the ladder 16 are round members, and the hooked portions 28a-b are curved or otherwise shaped to receive the round side rails. Moreover, in at least one embodiment, the ramped portions 30a-b each define a substantially flat ramped surface 36a-b.

In at least some embodiments, the bracket body 24 comprises a weldment comprising welded portions. For example, ramped portions 30a-b can be welded to the bracket body 24. In at least one embodiment and as shown, neither the bracket body 24 nor the locking mechanism 34 includes a threaded fastener for securing the bracket body to the ladder side rails 20a-b.

### Installation/Use

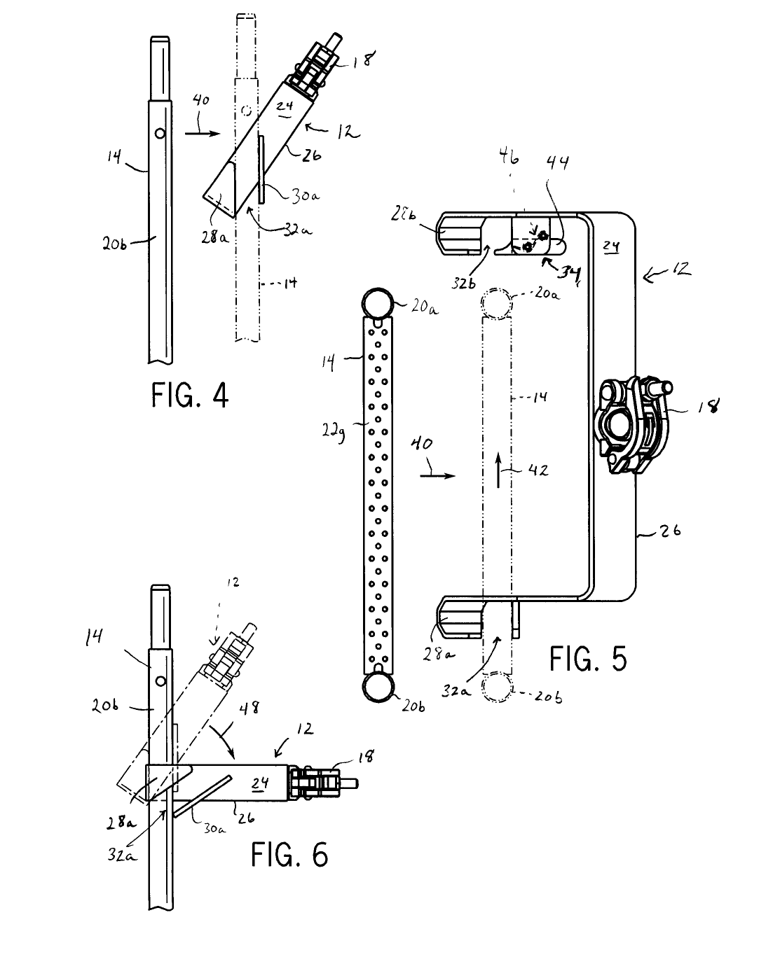

FIG. 4 is a side view of ladder 14 and the scaffold access ladder bracket assembly 12. FIG. 5 is a top view of FIG. 4. And FIG. 6 is a side view of the ladder 14 and the scaffold access ladder bracket assembly 12. FIGS. 4-5 show the ladder and assembly unconnected and FIG. 6 shows the objects connected. It is noted that installation, as described herein, is typically a manual process, however, automation of various aspects of the installation procedure are contemplated and considered within the scope of the present invention.

Referring to FIGS. 4-6, the ladder 14 again includes side rails 20a-b and cross piece 22g (FIG. 5) connected to the side rails as shown and noted above. The bracket assembly 12 again includes the bracket body 24 having the bent portion 26 terminating in hooked ends 28a-b (28b shown only in FIG. 5). The assembly 12 further includes the pair of ramped portions 30a-b which are connected to the bent portion 26 and spaced apart from the pair of hooked ends 28a-b to create the previously-noted pair of ladder receiving channels 32a-b (32b shown only in FIG. 5). Bracket assembly 12 further includes a clamping mechanism 18 for securing the assembly to a scaffold joint (not shown).

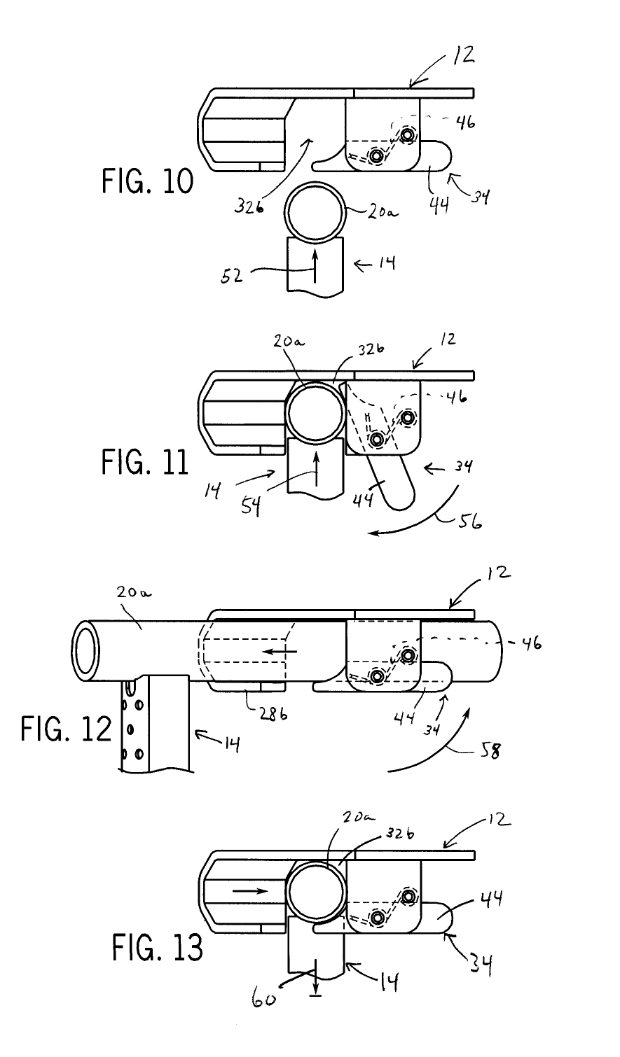

With specific reference to FIG. 5, and in accordance with at least some embodiments of the present invention, it can be seen that the bracket assembly 12 includes a locking 34 mechanism connected to the bracket body 24 for lockably and securably engaging the bracket body 24 to side rails 20a-b of the ladder. Such lockable engagement is described further below with reference to FIGS. 10-13. However, as shown and in accordance with at least some embodiments of the present invention, locking mechanism 34 includes a pawl mechanism 44 and a spring mechanism 46. Further, in accordance with at least some embodiments, the spring mechanism can include a torsion spring. For this reason, the locking mechanism 34, in at least some embodiments of the present invention, can be termed an “automatic locking mechanism” or a “spring loaded locking mechanism”.

Referring to FIGS. 4-5, and in accordance with at least at least one aspect of the invention, an installation procedure is disclosed. Ladder 14 is moved in relation to the scaffold access ladder bracket assembly 12 and such movement is indicated by arrow 40 (showing horizontal movement of the ladder to the right). The ladder 14 is moved until side rails 20a-b are positioned in relation to the ladder receiving channels 32a-b of the assembly 12. Such positioning is indicated by the ladder 14 being shown in phantom lines. With specific reference to FIG. 5, the ladder 14 (shown in phantom) is then moved in relation to the assembly 12 such the ladder side rails are positioned into and received by and into the ladder receiving channels 32a-b. Such movement is indicated by arrow 42. It is of note that, prior to movement of the ladder 14 into the ladder receiving channels 32a-b, the bracket assembly 12 is positioned or oriented at an angle that allows the channels 32a-b to receive the ladder side rails 20a-b. In at least some embodiments, orienting includes positioning the ladder side rails 20a-b parallel with the ramped portions 30a-b to facilitate receipt of the side rails into the ladder receiving channels 32a-b. It should be understood that, in FIGS. 4-5, the ladder is shown to be moved relative to the bracket assembly 12 to facilitate understanding. However, it is contemplated and considered within the scope of the present invention that the bracket assembly could also be moved with respect to the ladder, or alternatively, both objects could be moved toward one another.

Turning briefly to FIG. 6, once the scaffold access ladder bracket assembly 12 is initially engaged with the ladder 14 such that the ladder side rails 20a-b are positioned within, or substantially within, the ladder receiving channels 32a-b, the assembly is rotated to a final position with respect to the ladder. Such rotation is indicated by arrow 48. Once rotated, the ladder 14 is fully secured to and engaged with the scaffold access ladder bracket assembly 12. More specifically, the hooked ends 28a-b (only 28a is shown in FIG. 6) are secured around the side rails 20a-b (only 20b is shown in FIG. 6) of the ladder such that the hooked ends wedge the bracket body 24 of the assembly 12 against the pair of ladder side rails and against the ramped portions 30a-b (only 30a is shown in FIG. 6). Advantageously, the bracket assembly and ladder are now shown in secured engagement with one another and the ladder and bracket assembly are now in position to be securably connected to a scaffold joint. Thus, in order to disconnect the ladder from the bracket assembly, the above referenced steps would need to be reversed (and, as noted and described below, such disconnection would need to occur in a manner that, when a locking assembly is utilized, includes unlocking of the locking assembly).

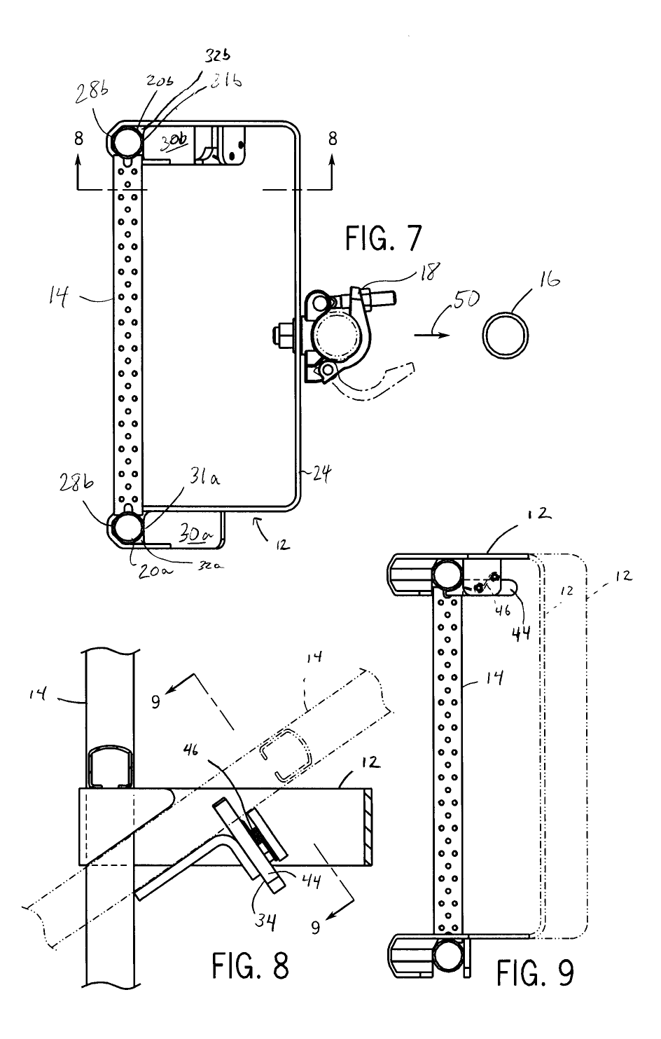

FIG. 7 illustrates a top view of the ladder 14 and the scaffold access ladder bracket assembly 12. The ladder 14 is shown connected to and in locking engagement with the assembly 12, with the ladder having been secured to the assembly (or vice versa) in accordance with the installation procedure previously described. The ladder side rails 20a-b are shown securely positioned within and in wedged engagement with the ladder receiving channels between hooked ends 28a-b and ramped portion ramped portions 30a-b, respectively, which themselves are secured to the bent portion 26 (shown in FIG. 5) of the bracket assembly body 24. It is further noted that ramped portion ends 31a-b of ramped portions 30a-b contact the ladder side rails 20a-b when the ladder and assembly are positioned as shown. This facilitates the wedged securing of the ladder 14 in relation to the hooked ends 28a-b, and more generally, to the scaffold access ladder bracket assembly 12.

Still referring to FIG. 7, the ladder 14 and assembly 12 can be secured to the scaffold joint 16 (again, for example, a conventional scaffold or scaffolding joint) via clamping mechanism 18, which is secured to the bracket body 24 of the assembly 12. This securing is typically accomplished by moving the assembly 12 (as shown when connected to the ladder 14) in relation to the scaffold joint 16, and such movement is indicated by arrow 50. As shown, the clamping mechanism 18 engages the scaffold joint 16 while in an open position. Then, once the joint 16 is positioned properly, the clamping mechanism 18 is moved to a closed position so as to securely fasten the mechanism (and thus the bracket and ladder) to the joint.

FIG. 8 is a sectional view of the ladder 14 and the scaffold access ladder bracket assembly 12 taken along line 8-8 of FIG. 7 and FIG. 9 is a top perspective view taken along line 9-9 of FIG. 8. Both FIGS. 8-9 illustrate the ladder 14 lockably engaged to the scaffold access ladder bracket assembly 12. The assembly 12, as shown in both FIGS. 8-9 includes a locking mechanism 34, which itself includes a pawl mechanism 44 and a spring mechanism 46 (shown in phantom in FIG. 9). With reference to FIG. 8, and in accordance with at least some embodiments of the present invention, the ladder 14 remains fastened and lockably secured to the bracket assembly 12 via locking mechanism 34 even while the ladder is rotated (e.g., 45 degrees clockwise). Such rotation or repositioning of the ladder 14 is indicated by the ladder being shown in phantom lines. And in FIG. 9, the ladder 14, in accordance with at least some embodiments of the present invention, remains lockably secured to the assembly 12 even when the bracket assembly is rotated with respect to the ladder. Such rotation or repositioning of the assembly 12 is indicated by the assembly being shown in phantom lines. In both FIGS. 8-9, the locking mechanism 34 retains the ladder in secured, locked relation to bracket assembly 12, and vice versa, despite relative rotational motion of the either the ladder 14 or the bracket assembly (or movement of both objects). In accordance with at least some embodiments of the present invention, manual actuation of the locking mechanism 34, in addition to relative rotation of the ladder 14 with respect to the bracket assembly 12, is required in order to disengage the ladder from the bracket assembly.

FIGS. 10-13 illustrate enlarged views showing various aspects of the present invention during and following installation. Referring to FIG. 10, side rail 20a of ladder 14 (a portion of which is shown) is moved towards the locking mechanism 34 and the ladder receiving channel 32b. Such movement is indicated by arrow 52. In the present embodiment, a locking mechanism 34 is included. The locking mechanism 34 is connected to the bracket assembly 12 includes pawl mechanism 44 and spring mechanism 46 (shown in phantom), and the locking mechanism is shown in a “closed” position.

With respect to FIG. 11, side rail 20a is shown to be positioned within the ladder receiving channel 32b of bracket assembly 12. More specifically, as the side rail 20a of ladder 14 enters the ladder receiving channel 32b, the locking mechanism 34, and more specifically the pawl mechanism 44 of the locking mechanism, rotates, thereby compressing the spring mechanism 46 (shown in phantom). Movement into the ladder receiving channel 32b is indicated by arrow 54. Rotation of the pawl mechanism 44 is indicated by arrow 56.

Referring to FIG. 12, the bracket assembly 12 is rotated with respect to the ladder 14 such that the hooked end 28b wedges against, so as to securely engage, the ladder side rail 20a. Once positioned as shown, the locking mechanism 34, and specifically the pawl mechanism 44, automatically rotates, due to extension of spring mechanism 46 (shown in phantom). In this fashion, the side rail 20a of the ladder 14 is lockably engaged. Such rotational movement is shown by arrow 58.

And turning to FIG. 13, the ladder side rail 20a is shown positioned similar to the position shown in FIG. 11 (i.e., within the ladder receiving channel 32b). To achieve the position shown, either the ladder 14 or the bracket assembly 12 is rotated following locking engagement of the locking mechanism as previously described. However, since the locking mechanism 34 is now fully engaged, the locking mechanism, and specifically the pawl mechanism 44, prevents the side rail 20a from moving with respect to the bracket assembly 12. Lack of movement is indicated by arrow with bar 60. Accordingly, in order to remove the ladder from the assembly, disengagement of the locking mechanism (e.g., in the example shown, rotation of the pawl mechanism 44) must take place prior to movement of the bracket assembly 12 with respect to the ladder 14 (or vice versa). The locking mechanism 34 can serve to reduce the likelihood of dislodging of the ladder during use and/or handling.

Methods are and have been disclosed herein. In accordance with one aspect of the present invention, a method of installing a scaffold access ladder having a pair of side rails on a scaffold is disclosed. The method comprises providing a scaffold access ladder bracket assembly, the assembly comprising: a bracket body that includes bent portion terminating in a pair of hooked ends, the hooked ends for wedging the bracket body against a pair of ladder side rails, and a pair of ramped portions connected to the bent portion and spaced apart from the pair of hooked ends to create a pair of ladder receiving channels for receiving the pair of ladder side rails. In at least some embodiments, a locking mechanism is included and connected to the bracket body for lockably engaging the bracket body to side rails of ladder. The method further includes orienting the bracket assembly with respect to the ladder side rails such that the ladder receiving channels can receive the pair of ladder side rails. The method still further includes initially engaging the bracket assembly onto the ladder such that the ladder side rails are positioned within, or substantially within, the ladder receiving channels. The method also includes rotating at least one of the bracket assembly and the ladder until the hooked ends of the bracket assembly are in wedged contact around the ladder side rails and such that the ladder is secured to and engaged with the bracket assembly. In at least some embodiments, the method further includes lockably engaging the bracket body of the bracket assembly to side rails of the ladder using the locking mechanism that engages at least one of the ladder side rails. In at least some embodiments, the rotating includes rotating either the bracket assembly or the ladder until the ramped portions are in abutting contact with the side rails of the ladder and such that the side rails are wedgingly secured within the hooked ends. And in at least some embodiments, the locking mechanism includes a pawl mechanism and a spring mechanism that permits the pawl mechanism to rotate between an open position and a closed position, and wherein, during the orienting, the locking mechanism is in a closed position.

Also disclosed and illustrated herein is a scaffold access ladder bracket assembly in combination with a ladder. The combination comprises a ladder having a pair of side rails and a plurality of cross pieces connected to the side rails. The combination also includes a scaffold access ladder bracket assembly. The assembly comprises a bracket body that includes bent portion terminating in a pair of hooked end portions, the hooked end portions for wedging the bracket body against a pair of ladder side rails, and a pair of ramped portions connected to the bent portion and spaced apart from the pair of hooked ends to create a pair of ladder receiving channels for receiving the pair of ladder side rails. In at least some embodiments, the assembly further includes a locking mechanism that is connected to the bracket body for lockably engaging the bracket body to side rails of the ladder. In accordance with at least some embodiments, the bracket assembly is lockably and securably engaged with the ladder by rotating the ladder within the ladder receiving channels. In accordance with at least some embodiments, the locking mechanism remains locked, once the assembly is lockably and securably engaged with the ladder, despite further rotation of either the ladder or the bracket assembly. And in accordance with at least some embodiments, the locking mechanism includes a pawl mechanism and a spring mechanism to permit the locking mechanism to move between an open position and a closed position.

In general, while the present invention has been shown and described in terms of a preferred embodiment(s), it is recognized that equivalents, alternatives, and modifications, aside from those expressly stated, are possible and within the scope of the appending claims.

Although the present invention is intended to be highly reliable, all physical systems are susceptible to failure and provision must be made for such failure. Accordingly, it is understood that safety, in an industrial process, depends on a wide variety of factors outside of the scope of the present invention including, for example: design of the system; installation and maintenance of the components of the system; the cooperation and training of individuals using the system; and consideration of the failure modes of the other components being utilized. No representation is made herein that the present invention in its various embodiments will make an industrial process safe, and no recommendation is made herein to utilize one preferred embodiment over, or to the exclusion of, another. Rather, the invention results in various advantages not achieved by prior solutions.

It is specifically intended that the present invention not be limited to the embodiments and illustrations contained herein, but include modified forms of those embodiments including portions of the embodiments and combinations of elements of different embodiments as come within the scope of the following claims.

1. A scaffold access ladder bracket assembly, the assembly comprising:
a bracket body that includes a bent portion terminating in a pair of hooked or hook-like ends, the ends for wedging the bracket body against a pair of ladder side rails, and a pair of ramped portions connected to the bent portion and spaced apart from the pair of ends to create a pair of ladder receiving channels for receiving the pair of ladder side rails; and
a locking mechanism connected to the bracket body for lockably engaging the bracket body to side rails of ladder.

2. The bracket assembly of claim 1 wherein the ends are used to create a rigid connection between the bracket body and the side rails.

3. The bracket assembly of claim 1 wherein the ends are profiled such that they at least partially encapsulate the side rails of the ladder.

4. The bracket assembly of claim 3 wherein the side rails are round and the ends include profiles that receive the round side rails.

5. The bracket assembly of claim 1 wherein the locking mechanism is an automatic locking mechanism that includes a pawl mechanism and a spring mechanism that permits the pawl mechanism to rotate between an open position and a closed position.

6. The bracket assembly of claim 5 wherein the automatic locking mechanism serves to reduce the likelihood of undesired dislodging of the ladder during use, handling, and/or dismantling.

7. The bracket assembly of claim 1 wherein the ramped portions each define an angled, substantially flat ramped surface, the ramped portions having ends that serve to secure the ladder in wedging contact with the hooked ends.

8. The bracket assembly of claim 7 wherein the locking mechanism remains locked, once the assembly is lockably and securably engaged with the ladder, despite rotation of either the ladder or the bracket assembly.

9. The bracket assembly of claim 1 wherein the ramped portions are welded to the bracket body.

10. The bracket assembly of claim 1 wherein the locking mechanism is connected to one of the ramped portions.

11. The bracket assembly of claim 1 wherein one of the ramped portions includes a locking mechanism support portion and the locking mechanism is connected or otherwise secured to the locking mechanism support portion.

12. The bracket assembly of claim 1 wherein neither the bracket body nor the locking mechanism includes a threaded fastener for securing the bracket body to the side rails of the ladder.

13. The bracket assembly of claim 1 further including a clamping mechanism for connecting the bracket body to a scaffold joint.

14. A method of installing a scaffold access ladder having a pair of side rails on a scaffold, the method comprising:
providing a scaffold access ladder bracket assembly, the assembly comprising:
a bracket body that includes a bent portion terminating in a pair of ends, the ends for wedging the bracket body against a pair of ladder side rails, and a pair of ramped portions connected to the bent portion and spaced apart from the pair of ends to create a pair of ladder receiving channels for receiving the pair of ladder side rails; and
orienting the bracket assembly with respect to the ladder side rails such that the ladder receiving channels can receive the pair of ladder side rails;
initially engaging the bracket assembly onto the ladder such that the ladder side rails are positioned within, or substantially within, the ladder receiving channels; and
rotating at least one of the bracket assembly and the ladder until the ends of the bracket assembly are in wedged contact with the ladder side rails and such that the ladder is secured to and engaged with the bracket assembly.

15. The method of claim 14 wherein the scaffold access ladder bracket assembly further comprises a locking mechanism connected to the bracket body and wherein the method further includes lockably engaging, using the locking mechanism, the bracket body of the bracket assembly to side rails of the ladder.

16. The method of claim 15 wherein the locking mechanism includes a pawl mechanism and a spring mechanism that permits the pawl mechanism to rotate between an open position and a closed position, and wherein, during the orienting and the rotating, the locking mechanism is in a closed position.

17. The method of claim 14 wherein the rotating includes rotating either the bracket assembly or the ladder until the ramped portions are in abutting contact with the side rails of the ladder such that the side rails are wedgingly secured within the ends.

18. A scaffold access ladder bracket assembly in combination with a ladder, the combination comprising:
a ladder having a pair of side rails and a plurality of cross pieces connected to the side rails; and
a scaffold access ladder bracket assembly, the assembly comprising:
a bracket body that includes a bent portion terminating in a pair of hooked end portions, the hooked end portions for wedging the bracket body against a pair of ladder side rails, and a pair of ramped portions connected to the bent portion and spaced apart from the pair of hooked ends to create a pair of ladder receiving channels for receiving the pair of ladder side rails; and
a locking mechanism connected to the bracket body for lockably engaging the bracket body to side rails of ladder;
wherein the bracket assembly is capable of being lockably and securably engaged with the ladder by rotating the ladder within the ladder receiving channels.

19. The combination of claim 18 wherein the locking mechanism remains locked, once the assembly is lockably and securably engaged with the ladder, despite further rotation of at least one of the ladder and the bracket assembly.

20. The combination of claim 19 wherein the locking mechanism includes a pawl mechanism and a spring mechanism to permit the locking mechanism to move between an open position and a closed position.

21. A scaffold access ladder bracket assembly, the assembly comprising:
a bracket body that includes a bent portion terminating in a pair of hooked or hook-like ends, the ends for wedging the bracket body against a pair of ladder side rails, and a pair of ramped portions connected to the bent portion and spaced apart from the pair of ends to create a pair of ladder receiving channels for receiving the pair of ladder side rails; and
wherein the bracket assembly is securably engaged with the ladder by rotating the ladder side rails within the ladder receiving channels.

22. The bracket assembly of claim 21 wherein the ends are used to create a rigid connection between the bracket body and the side rails.

23. The bracket assembly of claim 21 wherein the ends are profiled such that they can at least partially encapsulate the side rails of the ladder.

24. The bracket assembly of claim 23 wherein the side rails are round and the ends are profiled to receive the round side rails.

25. The bracket assembly of claim 21 wherein the ramped portions each define an angled, substantially flat ramped surface, the ramped portions having ends that serve to secure the ladder in wedging contact with the ends.

26. The bracket assembly of claim 21 wherein the ramped portions are welded to the bracket body.
